(19) United States
(12) Patent Application Publication
(10) Pub. No.: US 2011/0113073 A1
(43) Pub. Date: May 12, 2011

(54) METHOD FOR PROVIDING ADDRESS BOOK UNIFICATION SERVICE TO MOBILE TERMINAL

(75) Inventor: Gi-Jae CHANG, Daegu (KR)

(73) Assignee: SAMSUNG ELECTRONICS CO. LTD., Suwon-si (KR)

(21) Appl. No.: 12/912,056

(22) Filed: Oct. 26, 2010

(30) Foreign Application Priority Data
Nov. 12, 2009 (KR) 10-2009-0109349

(51) Int. Cl. G06F 17/30

(52) U.S. Cl. 707/803; 707/E17.005

(57) ABSTRACT

Provided is a method for providing an address book unification service to a mobile terminal. The method includes, when a plurality of Social Networking Services (SNSs) are executed, comparing information of each member of a specific SNS address book selected by a user with information of each member of an address book registered in at least one SNS, when the comparison results in a determination that values of a specific field among a plurality of data fields constituting information of each member of two SNS address books are equal to each other, creating a new address book including a preset number of data fields, and merging information of the two address books, the specific fields of which having an equal value, into the created address book.

### PRIORITY

This application claims the benefit under 35 U.S.C. §119(a) of a Korean patent application filed in the Korean Industrial Property Office on Nov. 12, 2009 and assigned Serial No. 10-2009-0109349, the entire disclosure of which is hereby incorporated by reference.

### BACKGROUND OF THE INVENTION

1. Field of the Invention

The present invention relates to a method for providing an address book unification service to a mobile terminal. More particularly, the present invention relates to a method for unifying and managing a plurality of community address books as one address book.

2. Description of the Related Art

As mobile terminals are becoming more widely used, communication service providers are providing various services to meet various demands of subscribers.

At present, mobile communication service providers not only allow calls to be free from location and time constraints, but also provide a variety of services, such as a wireless Internet service, a text message service, and a multimedia service, through mobile terminals. The text message service includes a Short Message Service (SMS), a Multimedia Messaging Service (MMS), and the like. Examples of the multimedia service include images, moving pictures, digital broadcasting, and so on.

The messaging service is achieved in such a manner as to originate/terminate a message composed by the user of a mobile communication terminal in a mobile communication system, which includes a base station, a mobile switching center, a home location register, a short message service center, etc. Such a message may be transferred between mobile communication terminals, or between a personal mobile communication terminal and information servers of providers who provide various information.

FIG. 1 is a view showing an example of a screen that displays an address book registered in a Social Networking Service (SNS) when the SNS is executed, according to the related art. An address book 100 registered in each SNS, such as Facebook, Skype, etc., is managed by a web server, and generally, includes a corresponding name or nickname, an SNS ID, an e-mail, and a telephone number.

Such an address book is present according to each SNS. According to the cooperation of various communities by the user, address books managed in a web environment are increasing in number, and thus duplicated address book information is increasing. Accordingly, it has become necessary to unify the management of address books.

Meanwhile, each SNS synchronizes address book information, unifies management thereof, and supports the exchange of address book information between address books. However, even in this case, only a copy of a local phone book managed in a web environment is available, or the user must manually unify duplicated information, thereby hindering convenience to the user.

### SUMMARY OF THE INVENTION

An aspect of the present invention is to address the above-mentioned problems and/or disadvantages and to provide at least the advantages described below. Accordingly, an aspect of the present invention is to provide a method for automatically unifying and managing a plurality of community address books, which exist in local phonebooks managed in a web environment according to the cooperation of various communities by the user based on a social networking service, as one address book.

In accordance with an aspect of the present invention, a method for providing an address book unification service to a mobile terminal is provided. The method includes, when a plurality of Social Networking Services (SNSs) are executed, comparing information of each member of a specific SNS address book selected by a user with information of each member of an address book registered in at least one SNS, when the comparison results in a determination that values of a specific field among a plurality of data fields constituting information of each member of two SNS address books are equal to each other, creating a new address book including a preset number of data fields, and merging information of the two address books, the specific fields of which having an equal value, into the created address book.

In accordance with another aspect of the present invention, a computer program product comprising a computer usable medium having control logic stored therein for causing a computer to provide an address book unification service is provided. The control logic includes a first computer readable program code means for causing the computer, when a plurality of Social Networking Services (SNSs) are executed, to compare information of each member of a specific SNS address book selected by a user, with information of each member of an address book registered in at least one SNS, a second computer readable program code means for causing the computer, when the comparison results in a determination that values of a specific field among a plurality of data fields constituting information of each member of two SNS address books are equal to each other, to create a new address book including a preset number of data fields, and a third computer readable program code means for causing the computer to merge information of the two address books, the specific fields of which having an equal value, into the created address book.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view showing an example of a screen which displays an address book registered in a Social Networking Service (SNS) when an SNS is executed, according to the related art;

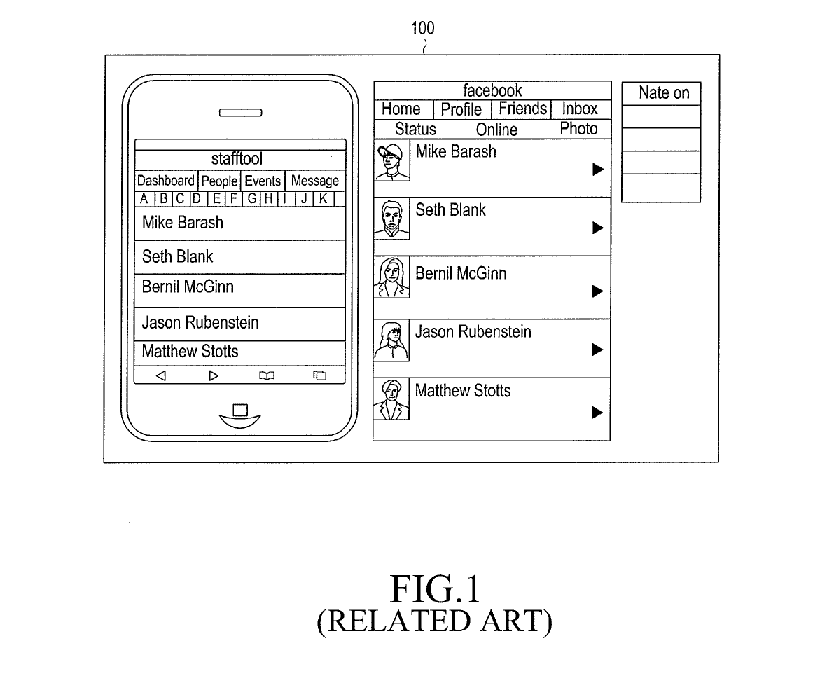

FIG. 2 is a flowchart illustrating the overall flow of a method for providing an address book unification service to a mobile terminal according to an exemplary embodiment of the present invention;

FIG. 3 is a flowchart illustrating the procedure performed when values of a specific field are not the same as each other as a result of the comparison of member information between SNS address books, in the method for providing an address book unification service to a mobile terminal according to an exemplary embodiment of the present invention;

FIGS. 4A to 4C are views schematically illustrating a plurality of data fields which constitute information of each member registered in an SNS address book according to an exemplary embodiment of the present invention; and

FIG. 5 is a view showing an example where data fields are not matched between two address books when the two address books are merged according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A mobile terminal is described herein as an example and corresponds to a complex terminal receiving a communication service through a wired/wireless public network. However, the present invention is not limited to such a mobile terminal. Therefore, it is apparent that the mobile terminal according to exemplary embodiments of the present invention may be a mobile communication terminal, and may be any information communication device or multimedia device, such as a digital broadcasting terminal, a Personal Digital Assistant (PDA), a smart phone, a 3^{rd} Generation (3G) terminal, and the like, or may be an application thereof. Here, the 3G terminal includes, for example, an International Mobile Telecommunication 2000 (IMT-2000) terminal, a Wideband Code Division Multiple Access (WCDMA) terminal, a Global System for Mobile communication/General Packet Radio Service (GSM/GPRS) terminal, and a Universal Mobile Telecommunication Service (UMTS) terminal.

Exemplary embodiments of the present invention propose a method for providing an address book unification service to a mobile terminal, which makes it possible to unify duplicated address book entries in address books according to Social Networking Services (SNSs) into one address book in order to enable an SNS-based messaging service to be easily provided through the mobile terminal.

To this end, according to the method of the exemplary embodiments of the present invention, values of a specific field or values of the remaining fields, except for the specific field, among a plurality of data fields constituting address book information according to SNSs managed in a web environment are compared according to the user's request, and then duplicated address information is unified into a new address book and is managed, so that it is possible to simply and easily perform each SNS through the unified address book, without having to access a plurality of SNSs.

Also, in performing the method according to exemplary embodiments of the present invention, it is assumed that a step of determining if a character stream having a plurality of characters is included is performed before data fields are compared between pieces of address-related information.

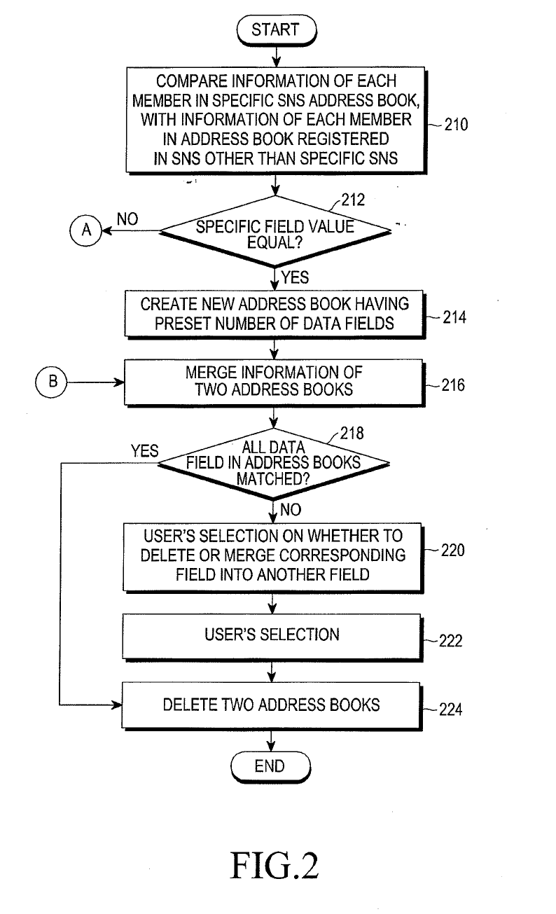

In connection with this, the method according to an exemplary embodiment of the present invention will now be described in detail with reference to FIG. 2.

FIG. 2 is a flowchart illustrating the overall flow of a method for providing an address book unification service to a mobile terminal according to an exemplary embodiment of the present invention.

Referring to FIG. 2, first, upon execution of a plurality of SNSs, information of each member in a specific SNS address book selected by the user is compared with information of each member in an address book registered in one or more SNSs, other than the specific SNS, in step 210.

In this case, the comparison step is performed in regular sequence in such a manner as to match information of each member in the specific SNS address book with information of each member in the one or more SNSs in one-to-one correspondence.

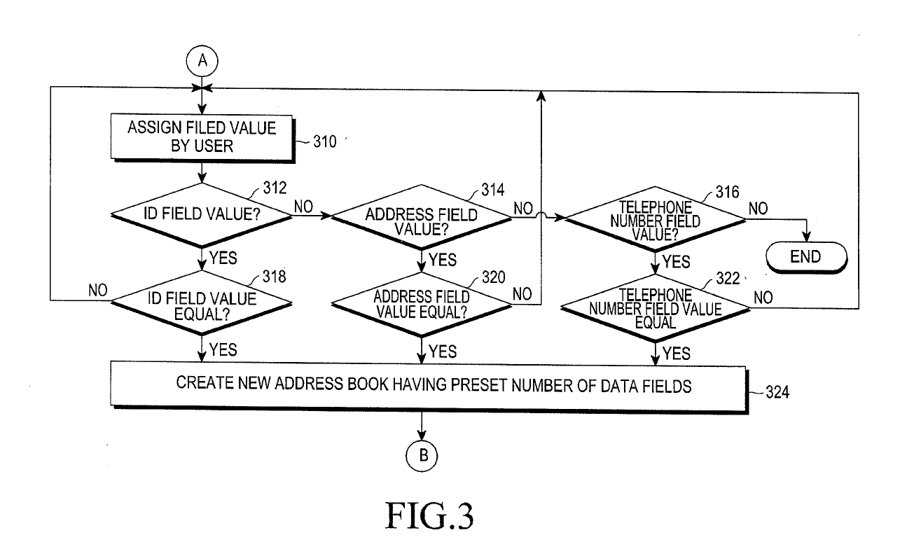

Next, it is determined in step 212 if the value of a specific field among a plurality of data fields constituting information of a specific member in the specific SNS address book is the same as that included among information of a member in the one or more SNSs as a result of the comparison. If it is determined that the value of a specific field among a plurality of data fields constituting information of a specific member in the specific SNS address book is not the same as that included among information of a member in the one or more SNSs as a result of the comparison, the process proceeds to step 310, which is described further below with reference to FIG. 3. However, if it is determined that the value of a specific field among a plurality of data fields constituting information of a specific member in the specific SNS address book is the same as that included among information of a member in the one or more SNSs as a result of the comparison, a new address book having a preset number of data fields is created in step 214 when the value of the specific field is the same as that included among information of a member in the one or more SNSs.

Here, the value of the specific field represents the name of each member registered in the address book of each SNS, that is, represents a name field value.

Next, in step 216, information of members, for which the specific fields have the same value, in the two address books are merged into the created address book, so that one address book is completed.

It is determined in step 218 if two address books merged in the merging step are matched with each other in terms of all the data fields. When all of the data fields are matched between the two address books, the process proceeds to step 224, which is described further below. When there is a data field which is not matched between the two address books, the procedure proceeds to step 220 of waiting for the user's selection on whether to delete or to merge the data field, which has been determined to be a non-matched field as a result of the determination, into another field.

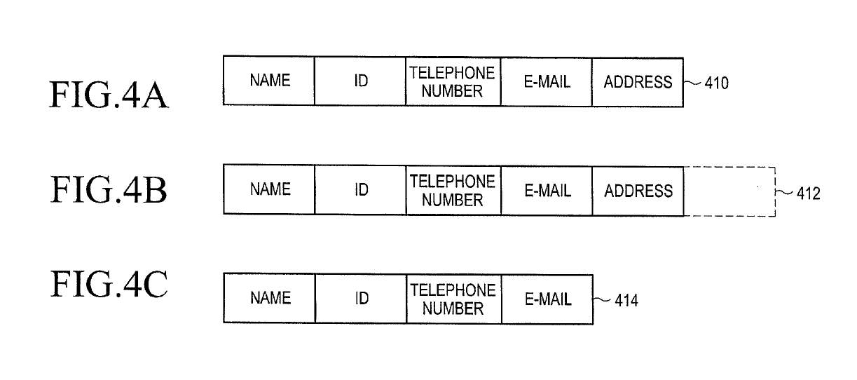

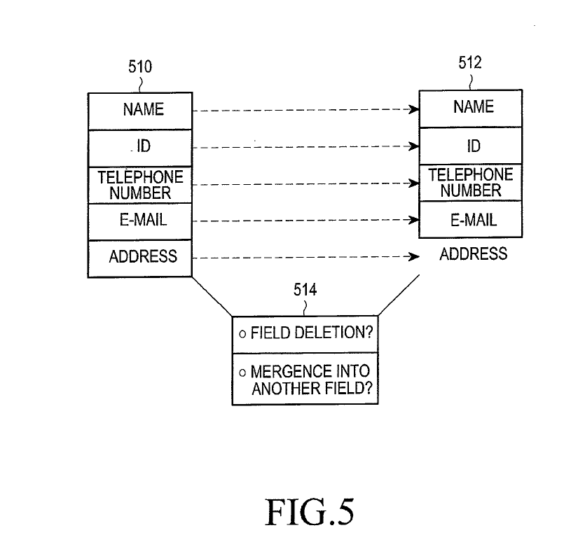

Step 220 will be described in more detail with reference to FIGS. 4A to 4C and FIG. 5.

FIGS. 4A to 4C are views schematically illustrating a plurality of data fields which constitute information of each member registered in an SNS address book according to an exemplary embodiment of the present invention.

Referring to FIG. 4A, generally, the plurality of data fields constituting information of each member registered in the SNS address book include a name field for recording the name of the member, an IDentifier (ID) field, a telephone number field, an e-mail field, and an address field.

In addition, when it is determined in step 218 if all the data fields between two address books are matched with each other, it is determined if a name field is matched with a name field of member information of an address book into which the merging is to be performed, and if an ID field is matched with an ID field of member information of an address book into which the merging is to be performed, that is, it is determined if each field is matched with each corresponding field.

In this case, a field of one address book among member information of two address books to be merged may not be matched, as shown in FIGS. 4A-4C. More specifically, one address book may have either the configuration of a data field 412 further including a predefined field as shown in FIG. 4B, that is different from the configuration of a data field 410 as shown in FIG. 4A, or may have the configuration of a data field 414 not including a predefined field as shown in FIG. 4C. As shown in FIG. 5, in step 220, when the one address book has the configuration of a mismatched data field, that is, such as the mismatched data fields between address book 510 and address book 512, the configuration of a data field further including an additional field, the user is notified of whether to delete or to merge the additional field into another field by a pop-up window 514.

Also, in step 220, one data field value selected by the user from among the remaining data field values, except for a specific field value, is compared between two address books. In this case, when there is the same data field value between the two address books, any one of specific field values which are mutually different between the two address books, for example, a member name in any one address book of two member names, is selected and determined as the specific field value, and the non-selected member name in the other address book is merged into an additional name field when a data field corresponds to a data field 412 including a remaining field, as shown in FIG. 4B.

Thereafter, the user's selection is received in step 222. Next, the created address book is completed by deleting or merging the corresponding field into another field according to a result of the user's selection, and then the two address books used for merging are deleted in step 224.

Meanwhile, in step 212, where it is determined if the value of a specific field among a plurality of data fields constituting information of a specific member in the specific SNS address book is the same as that included among information of a member in the one or more SNSs, when it is determined that the values of the specific fields are not the same, the procedure proceeds along “A” to step 310.

FIG. 3 is a flowchart illustrating the procedure performed when values of a specific field are not the same as each other as a result of the comparison of member information between SNS address books, in the method for providing an address book unification service to a mobile terminal according to an exemplary embodiment of the present invention.

Referring to FIG. 3, first, in step 310, any one field value selected by the user from among the values of the remaining data fields, except for the specific field, is assigned. In step 312 it is determined if the data field value selected by the user corresponds to an ID field value.

When it is determined that the data field value selected by the user corresponds to an ID field value, the procedure proceeds to step 318, where it is determined if the ID field values of the two address books are the same as each other.

When the ID field values are the same as a result of the determination, the procedure proceeds to step 324, where a new address book having a preset number of data fields (for example, data fields as shown in FIG. 4A) is created. In contrast, when the ID field values are not the same as a result of the determination, the procedure returns to step 310 and waits for the user's selection.

When it is determined that the data field value selected by the user does not correspond to an ID field value in step 312, the procedure proceeds to step 314. In step 314 it is determined if the data field value selected by the user in step 310 corresponds to an address field value. When it is determined in step 314 that the data field value selected by the user in step 310 corresponds to an address field value, the procedure proceeds to step 320, where it is determined if the address field values of the two address books are the same as each other.

When the address field values are the same as a result of the determination, the procedure proceeds to step 324, where a new address book having a preset number of data fields (for example, data fields as shown in FIG. 4A) is created. In contrast, when the address field values are not the same as a result of the determination, the procedure returns to step 310 and waits for the user's selection.

When it is determined that the data field value selected by the user in step 310 does not correspond to an address field value in step 314, the procedure proceeds to step 316. In step 316 it is determined if the data field value selected by the user in step 310 corresponds to a telephone number field value. When it is determined in step 316 that the data field value selected by the user in step 310 corresponds to a telephone number field value, the procedure proceeds to step 322, where it is determined if the telephone number field values of the two address books are the same as each other.

When the telephone number field values are the same as a result of the determination, the procedure proceeds to step 324, where a new address book having a preset number of data fields (for example, data fields as shown in FIG. 4A) is created. In contrast, when the telephone number field values are not the same as a result of the determination, the procedure returns to step 310 of waiting for the user's selection. When it is determined that the data field value selected by the user in step 310 does not correspond to a telephone number field value in step 316, the procedure ends.

Meanwhile, step 322 of comparing the telephone number field values with each other may be performed in such a manner as to classify a unique number assigned to a corresponding mobile terminal, i.e. a telephone number including a mobile station identification number, according to pre-allocated digits and to sequentially perform the comparison operation.

After step 324, the procedure proceeds along “B,” shown in FIG. 2.

The method for providing an address book unification service to a mobile terminal may be implemented as described above.

According to exemplary embodiments of the present invention, a plurality of community address books which exist according to the cooperation of various communities by the user based on a social networking service are unified into one address book and are managed, so that it is possible to rapidly search for information on a desired address book, and also the unified address book facilitates management by the user.

Certain aspects of the present invention may also be embodied as control logic stored on a computer useable medium that causes a computer to process the control logic so as to operate in a manner corresponding to the control logic. The control logic comprises one or more computer readable program code means. A computer useable medium is any data storage device that can store data, which may be thereafter read by a computer system. Examples of the computer useable medium include Read-Only Memory (ROM), Random-Access Memory (RAM), CD-ROMs, magnetic tapes, floppy disks, and optical data storage devices. The computer useable medium can also be distributed over network coupled computer systems so that the computer readable code is stored and executed in a distributed fashion. Also, functional programs, code, and code segments for accomplishing the present invention may be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing an address book unification service to a mobile terminal, the method comprising:
when a plurality of Social Networking Services (SNSs) are executed, comparing information of each member of a specific SNS address book selected by a user with information of each member of an address book registered in at least one SNS;
when the comparison results in a determination that values of a specific field among a plurality of data fields constituting information of each member of two SNS address books are equal to each other, creating a new address book including a preset number of data fields; and
merging information of the two address books, the specific fields of which having an equal value, into the created address book.

2. The method of claim 1, wherein the specific field corresponds to a name field of each member.

3. The method of claim 1, wherein, the merging of information of the two address books comprises:
determining if all of the data fields are matched between the two address books; and
when it is determined that not all of the data fields are matched between the two address book, notification is given to the user by a pop-up window to enable the user to delete or to merge a non-matched field into another field.

4. The method of claim 1, further comprising:
when the comparison results in a determination that the values of the specific field are not equal, comparing values of one data field selected by the user among values of remaining data fields, except for the specific field.

5. The method of claim 4, further comprising:
when the comparison results in a determination that the values of one data field selected by the user among the values of the remaining data fields, except for the specific field, are equal to each other, creating a new address book including the preset number of data fields;
selecting a first specific field's value of the two specific field's values mutually different between the two address books, and one of deleting and adding a second first specific field's value of the two specific field's values to a remaining data field of the created address book; and
merging information of two address books, in which values of one data field selected by the user are equal, into the created address book.

6. The method of claim 5, wherein, the merging of information of the two address books comprises:
determining if a data field of a specific address book is not matched with a data field of an address book into which the merging is to be performed; and
when it is determined that a data field of a specific address book is not matched with a data field of an address book into which the merging is to be performed, a notification is given to the user by a pop-up window to enable the user to delete or to merge the non-matched field into another field.

7. The method of claim 1, wherein the information of each member comprises at least one of an IDentifier (ID), an address, a telephone number and an e-mail address.

8. The method of claim 1, wherein the SNS address book corresponds to an address book managed in a web environment.

9. The method of claim 5, wherein the remaining data field corresponds to one of an IDentifier (ID), an address, a telephone number and an e-mail address of each member.

10. The method of claim 1, wherein, when two address books are merged into the created address book, the two address books are deleted.

11. A computer program product comprising a computer usable medium having control logic stored therein for causing a computer to provide an address book unification service, the control logic comprising:
a first computer readable program code means for causing the computer, when a plurality of Social Networking Services (SNSs) are executed, to compare information of each member of a specific SNS address book selected by a user with information of each member of an address book registered in at least one SNS;
a second computer readable program code means for causing the computer, when the comparison results in a determination that values of a specific field among a plurality of data fields constituting information of each member of two SNS address books are equal to each other, to create a new address book including a preset number of data fields; and
a third computer readable program code means for causing the computer to merge information of the two address books, the specific fields of which having an equal value, into the created address book.

12. The computer program product of claim 11, wherein the specific field corresponds to a name field of each member.

13. The computer program product of claim 11, wherein, the third computer readable program code means comprises:
computer readable program code means for causing the computer to determine if all of the data fields are matched between the two address books, and when it is determined that not all of the data fields are matched between the two address book, to notify the user by a pop-up window to enable the user to delete or to merge a non-matched field into another field.

14. The computer program product of claim 11, further comprising:
a fourth computer readable program code means for causing the computer, when the comparison results in a determination that the values of the specific field are not equal, to compare values of one data field selected by the user among values of remaining data fields, except for the specific field.

15. The computer program product of claim 14, further comprising:
a fifth computer readable program code means for causing the computer, when the comparison results in a determination that the values of one data field selected by the user among the values of the remaining data fields, except for the specific field, are equal to each other, to create a new address book including the preset number of data fields;
a sixth computer readable program code means for causing the computer to select a first specific field's value of the two specific field's values mutually different between the two address books, and one of deleting and adding a second first specific field's value of the two specific field's values to a remaining data field of the created address book; and
a seventh computer readable program code means for causing the computer to merge information of two address books, in which values of one data field selected by the user are equal, into the created address book.

16. The computer program product of claim 15, wherein, the third computer readable program code means comprises:
computer readable program code means for causing the computer to determine if a data field of a specific address book is not matched with a data field of an address book into which the merging is to be performed, and, when it is determined that a data field of a specific address book is not matched with a data field of an address book into which the merging is to be performed, to notify the user by a pop-up window to enable the user to delete or to merge the non-matched field into another field.

17. The computer program product of claim 11, wherein the information of each member comprises at least one of an IDentifier (ID), an address, a telephone number and an e-mail address.

18. The computer program product of claim 11, wherein the SNS address book corresponds to an address book managed in a web environment.

19. The computer program product of claim 15, wherein the remaining data field corresponds to one of an IDentifier (ID), an address, a telephone number and an e-mail address of each member.

20. The computer program product of claim 11, wherein, when two address books are merged into the created address book, the two address books are deleted.
